(19) United States
(12) Patent Application Publication
(10) Pub. No.: US 2004/0133579 A1
(43) Pub. Date: Jul. 8, 2004

(54) Language neutral syntactic representation of text

(76) Inventor: Richard Gordon Campbell, Redmond, WA (US)

Correspondence Address: Joseph R. Kelly, WESTMAN CHAMPLIN & KELLY, International Centre, 900 South Second Avenue, Suite 1600, Minneapolis, MN, 55402-3319, US

(21) Appl. No.: 10/337,085

(22) Filed: Jan. 6, 2003

(51) Int. Cl. G06F 7/00

(52) U.S. Cl. 707/100

(57) ABSTRACT

A data structure represents a textual string. The data structure is in the form of an annotated tree that includes nodes, each node having at most one parent node and a set of unordered, immediate constituents, each immediate constituent of a node being identified by a semantic relation to the node.

### BACKGROUND OF THE INVENTION

The present invention relates to processing of natural language inputs. More particularly, the present invention relates to a language-neutral representation of input text.

A wide variety of applications would find it beneficial to accept inputs in natural language. For example, if machine translation systems, information retrieval systems, command and control systems (to name a few) could receive natural language inputs from a user, this would be highly beneficial to the user.

In the past, this has been attempted by first performing a surface-based syntactical analysis on the natural language input to obtain a syntactic analysis of the input. Of course, the surface syntactic analysis is particular to the individual language in which the user input is expressed, since languages vary widely in constituent order, morphosyntax, etc.

Thus, the surface syntactic analysis was conventionally subjected to further processing to obtain some type of semantic of quasi-semantic representation of the natural language input. Some examples of such semantic representations include the Quasi Logical Form_{[rgc1]} in Alashawi et al., TRANSLATION BY QUASI LOGICAL FORM TRANSFER, Proceedings of ACL 29:161-168 (1991); the Underspecified Discourse Representation Structures set out in Reyle, DEALING WITH AMBIGUITIES BY UNDER SPECIFICATION: CONSTRUCTION, REPRESENTATION AND DEDUCTION, Journal of Semantics 10:123-179 (1993); the Language for Underspecified Discourse Representations set out in Bos, PREDICATE LOGIC UNPLUGGED, Proceedings of the Tenth Amsterdam Colloquium, University of Amsterdam (1995); and the Minimal Recursion Semantics set out in Copestake et al., TRANSLATION USING MINIMAL RECURSION SEMANTICS, Proceedings of TMI-95 (1995), and Copestake et al., MINIMAL RECURSION SEMANTICS: AN INTRODUCTION, MS., Stanford University (1999).

While such semantic representations can be useful, it is often difficult, in practice, and unnecessary for most applications, to have a fully articulated logical or semantic representation. For example, consider the Adjective+Noun combinations “black cat” and “legal problem”. Both combinations have identical surface structures, but very different semantics. The first is interpreted as describing something that is both a cat and black. The second, however, does not have the parallel interpretation as a description of something that is both a problem and legal. Instead, it typically describes a problem having to do with the law.

In order to accurately analyze this distinction, a system would require extensive and detailed lexical annotations for adjective senses, and most likely, for lexicalized meanings of particular Adjective+Noun combinations. Such extensive annotation, if it is even possible, would render a system that depends on it very brittle.

For most applications, however, this semantic difference is immaterial, and the extensive and brittle annotation is unnecessary. For example, in a machine translation system, all that is required to translate the phrases into the French equivalents “chat noir” which is literally translated as “cat black” and “probléme legal” which is literally translated as “problem legal” is that the adjective modifies the noun in some way.

### SUMMARY OF THE INVENTION

A data structure represents a textual string. The data structure is in the form of an annotated tree that includes nodes, each node having at most one parent node and a set of unordered, immediate constituents, each immediate constituent of a node being identified by a semantic relation to the node.

The data structure represents the logical arrangement of the parts of the input string, substantially independent of arbitrary, language-particular aspects of structure such as word order, inflectional morphology, function words, etc. The data structure thus occupies a middle ground between surface-based syntax and a full semantic analysis, as being a semantically motivated language-neutral syntactic representation.

### BRIEF DESCRIPTION OF THE DRAWINGS

FIG. 1 is a block diagram of one illustrative embodiment of a computer in which the present invention can be used.

FIG. 2 illustrates an environment in which the representation of the present invention can be used.

FIG. 3 illustrates a continuum of representations between a surface representation and a semantic representation, and shows where the representation of the present invention resides along the continuum.

FIG. 4 is a block diagram illustrating a representation in accordance with one embodiment of the present invention.

FIGS. 5A and 5B show a prior semantic dependency structure and syntactic representation, respectively, of a phrase.

FIG. 5C illustrates a representation for the phrase represented in FIGS. 5A and 5B, in a representation structure in accordance with one embodiment of the present invention.

FIGS. 6A and 6B illustrate a prior semantic dependency structure and syntactic representation, respectively, for a phrase which includes modifiers.

FIG. 6C illustrates a representation of the phrase represented in FIGS. 6A and 6B, in accordance with one embodiment of the present invention.

FIG. 7 is a block diagram of a system for generating representations.

FIG. 8 is a flow diagram illustrating the application of modifier scope rules in accordance with one embodiment of the present invention.

FIG. 9 is a block diagram of a system for generating semantic representations for use by applications.

FIG. 10 is a representation of a sentence in accordance with one embodiment of the present invention.

FIG. 11 is a predicate-argument structure (PAS) generated from the representation shown in FIG. 10.

### DETAILED DESCRIPTION OF ILLUSTRATIVE EMBODIMENTS

The present invention relates to a representation structure for representing a surface string in a substantially language neutral and application neutral way. However, prior to describing the present invention in greater detail, one environment in which the present invention can be used will now be described.

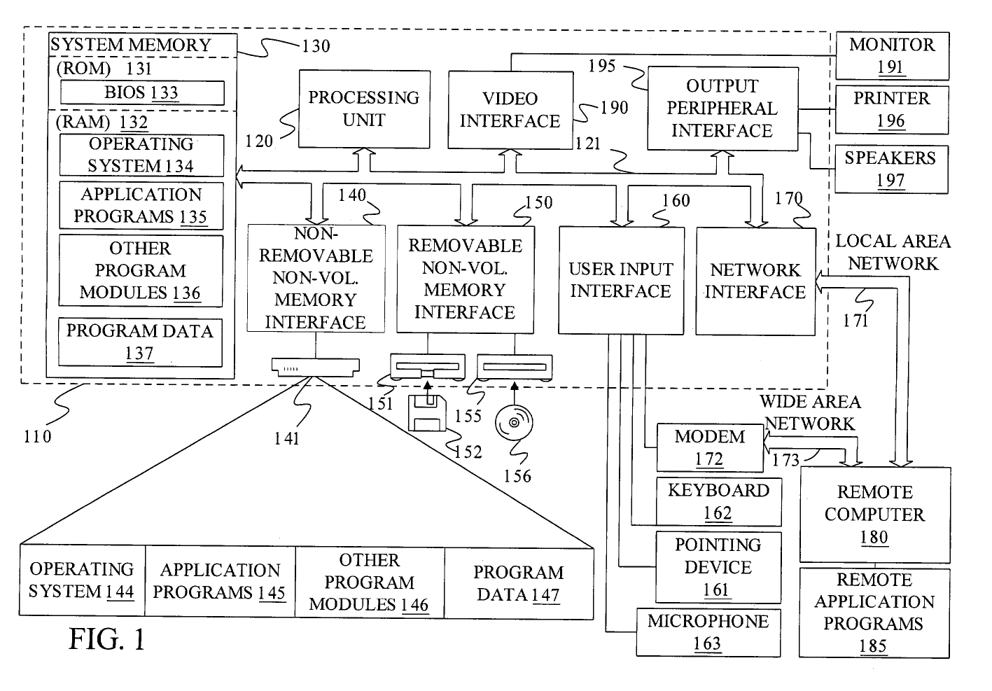

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 100. Communication media typically embodies computer readable instructions, data structures, program modules or other data in a modulated data signal such as a carrier WAV or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, FR, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way o example, and not limitation, FIG. 1 illustrates operating system 134, application programs 135, other program modules 136, and program data 137.

The computer 110 may also include other removable/non-removable volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies.

A user may enter commands and information into the computer 110 through input devices such as a keyboard 162, a microphone 163, and a pointing device 161, such as a mouse, trackball or touch pad. Other input devices (not shown) may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a hand-held device, a server, a router, a network PC, a peer device or other common network node, and typically includes many or all of the elements described above relative to the computer 110. The logical connections depicted in FIG. 1 include a local area network (LAN) 171 and a wide area network (WAN) 173, but may also include other networks. Such networking environments are commonplace in offices, enterprise-wide computer networks, Intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user-input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on remote computer 180. It will be appreciated that the network connections shown are exemplary and other means of establishing a communications link between the computers may be used.

It should be noted that the present invention can be carried out on a computer system such as that described with respect to FIG. 1. However, the present invention can be carried out on a server, a computer devoted to message handling, or on a distributed system in which different portions of the present invention are carried out on different parts of the distributed computing system.

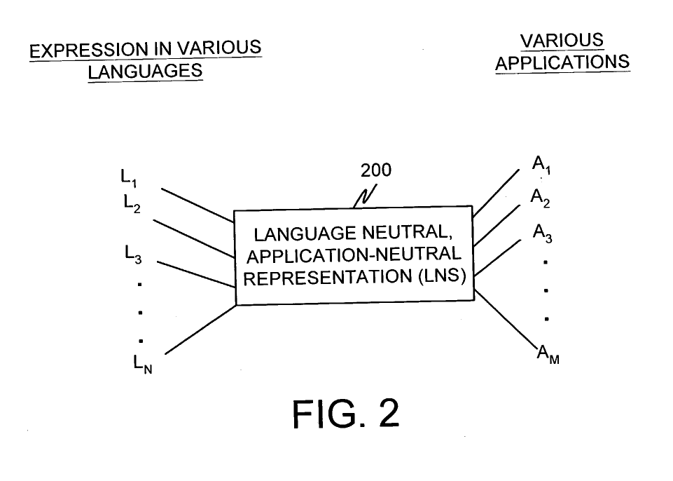

FIG. 2 illustrates a problem addressed by the present invention. FIG. 2 illustrates that a natural language expression which is to be input to a natural language processing application can be expressed in one of many different languages L1-LN. FIG. 2 also illustrates that such a natural language expression may be acceptable as an input to any number of a wide variety of applications A1-AM. Because the expressions will differ with each language, and because the inputs required by each application may be different, it can be seen that in conventional systems, in order to accommodate the environment shown in FIG. 2, the number of representations which may be required for a single natural language input may be as many as N×M.

Therefore, in accordance with one embodiment of the present invention, the natural language input is represented, regardless of the language in which it is originally expressed, in a substantially language-neutral and substantially application-neutral representation structure 200. Representation 200 can be used as an input to anyone of applications A1-AM, or it can be used to readily derive an input to applications A1-AM.

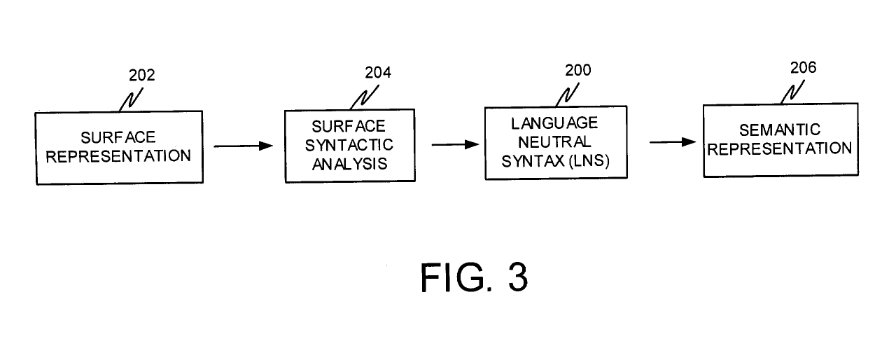

FIG. 3 illustrates a continuum of representations between a natural language input 202 which is a surface representation, and a full semantic representation 206. Performing well-known syntactic analysis on surface representation 202 yields a surface syntactic analysis structure 204. Traditionally, the surface syntactic analysis 204 has been further processed, in a known way, into a semantic representation (or semantic dependency structure) 206. The representation in accordance with the present invention is a substantially language neutral syntax (LNS) 206 which is substantially language-neutral, and application-neutral. Representation 200 thus occupies a middle ground between surface-based syntax and a full-fledged semantic analysis, being neither a comprehensive semantic representation, nor a syntactic analysis, of a particular language. Instead, representation 200 is a semantically motivated, substantially language-neutral syntactic representation. Representation 200 represents the logical arrangement of the parts of a sentence, independent of arbitrary, language-particular aspects of structure such as word order, inflectional morphology, function words, etc.

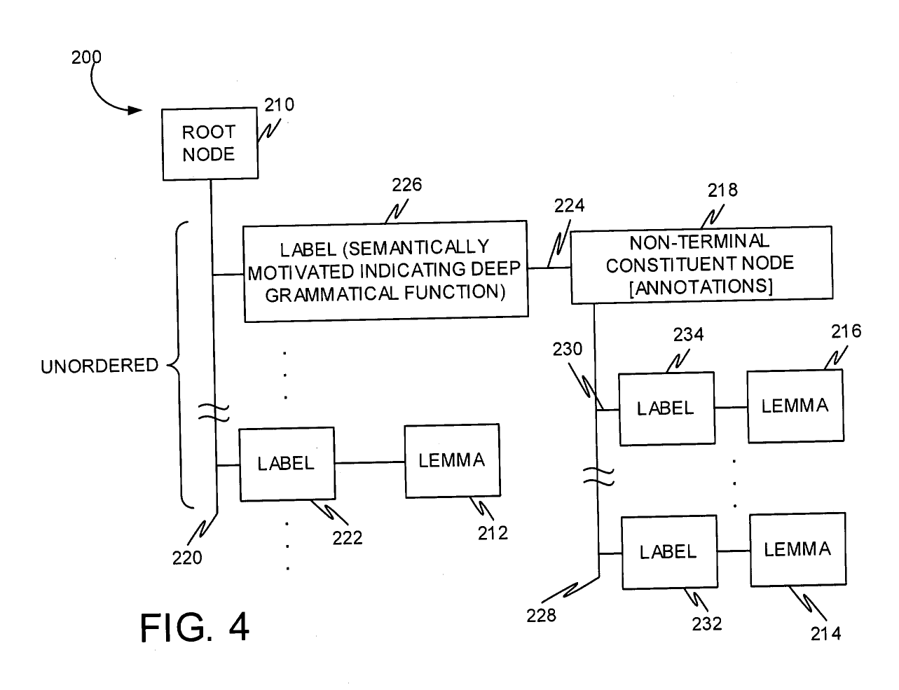

FIG. 4 is a block diagram illustrating one exemplary structure of LNS 200. The LNS representation of a sentence (or other textual input string) is an annotated tree structure in that it includes a plurality of nodes and each node has at most one parent. However, structure 200 differs from a surface syntactic analysis (such as 204 shown in FIG. 3) in that constituents are unordered and in that the immediate constituents of a given node are identified by labeled arcs indicating a semantically motivated relation to the parent node.

In the example shown in FIG. 4, LNS representation 200 is a tree structure having a root node 210, leaf nodes (or terminal nodes) 212, 214 and 216 which are lemmatized representations of words in the surface input string, and one or more additional non-terminal nodes 218 which represent constituents. The terminal nodes can also be abstract expressions, such as variables. Nonterminal nodes 210 and 218 correspond roughly to the phrasal and sentential nodes of traditional syntactic trees.

Each of the nodes 212-218 are connected to at most one parent node by a labeled arc. For example, terminal node 212 is connected to root node 210 by arc 220 that has a label 222. Similarly, non-terminal constituent node 218 is connected to root node 210 by arc 224 which is labeled by label 226. The other nodes 214 and 216 are also connected to parent node 218 by arcs 228 and 230, each of which have a label 232 and 234, respectively.

The branches of the tree 200 are unordered in that the order in which the child nodes depend from a parent node is arbitrary. The LNS 200 is fully specified by defining a dominance relation among the nodes and specifying the attributes (including relations to other nodes) and further by annotating the nodes with features that represent linguistic characteristics of each node. Labels 222, 226, 232 and 234, which label the arcs between parent and child nodes, represent deep grammatical functions (such as logical subject, logical object, etc.) and other semantically motivated relations.

One exemplary set of semantic relations used to label arcs between nodes in the tree structure (also referred to as “tree attributes”) is set out in Table 1 below.

TABLE I
Basic tree attributes: note that if x == attr(y),
then y is x's parent

| Attribute | Usage | Examples |
|---|---|---|
| L_Sub | “logical subject”: agent, actor, | She took it; |
| | cause or other underlying subject | John ran; |
| | relation; not e.g. subject of | It was done by |
| | passive, raising, or unaccusative | me; you are |
| | predicate; also used for subject | tall. |
| | of predication | |
| L_Ind | “logical indirect object”: goal, | I gave it to |
| | recipient, benefactive | her; I was |
| | | given a book |
| L_Obj | “logical (direct) object”: theme, | She took it; |
| | patient, including e.g. subject of | The window |
| | unaccusative; also object of | broke; He was |
| | preposition | seen by |
| | | everyone |
| L_Pred | “logical predicate”: secondary | We painted the |
| | predicate, e.g. resultative or | barn red; I saw |
| | depictative | them naked |
| L_Loc | location | I saw him there |
| L_Time | time when | He left before |
| | | I did; He left |
| | | at noon |
| L_Dur | duration | I slept for six |
| | | hours |
| L_Caus | cause or reason | I slept because |
| | | I was tired; |
| | | She left |
| | | because of me |
| L_Poss | possessor | my book; some |
| | | friends of his |
| L_Quant | quantifier/determiner | three books; |
| | | every woman; |
| | | all of them; |
| | | the other |
| | | people |
| L_Mods | otherwise unresolved modifier | I left quickly |
| L_Crd | conjunction in coordinate | John and Mary |
| | structure | |
| L_Interlocs | interlocutor(s), addressee(s) | John, come |
| | | here! |
| L_Appostn | appositive | John, my |
| | | friend, left |
| L_Purp | purpose clause | I left to go |
| | | home; His wife |
| | | drove so that |
| | | he could sleep; |
| | | I bought it in |
| | | order to please |
| | | you |
| L_Intns | intensifier | He was very |
| | | angry. |
| L_Attrib | attributive modifier (adjective, | the green |
| | relative clause, or similar | house; the |
| | function) | woman that I |
| | | met. |
| L_Means | means by which | He covered up |
| | | by humming. |
| L_Class | classifier; often this is the | a box of |
| | grammatical head but not the | crackers |
| | logical head | |
| OpDomain | scope domain of a sentential | He did not |
| | operator | leave |
| ModalDomain | scope domain of a modal | I must leave. |
| | verb/particle | |
| SemHeads | logical function: head or | He did not |
| | sentential operator | leave; my good |
| | | friend; He |
| | | left. |
| Ptcl | particle forming a phrasal verb | He gave up his |
| | | rights |

The LNS tree structure 200 can also have non-tree attributes which are annotations of the tree, but per se not part of the tree itself, and indicate a relationship between nodes in the tree. An exemplary set of basic non-tree attributes is set out in Table 2 below, and an exemplary set of features used as annotations to annotate the nodes in an LNS tree structure is set out in Table 3.

TABLE II
Basic non-tree attributes

| | Type of | | |
|---|---|---|---|
| Attribute | value | Usage | Attribute of |
| Cntrlr | single | Controller or binder of | dependent item |
| | node | dependent element | |
| L_Top | list of | Logical topic | clause |
| | nodes | | |
| L_Foc | list of | Focus, e.g. of | clause |
| | nodes | pseudo(cleft) | |
| PrpObj | single | Object of | node headed by |
| | node | pre/postposition (often | pre/postposition |
| | | also L_Obj; see Table I) | |
| Nodename | string | Unique name/label of an | all nodes |
| | | LNS node; the value of | |
| | | Nodename is the value of | |
| | | Pred (for terminal | |
| | | nodes) or Nodetype□(for | |
| | | nonterminal nodes) | |
| | | followed by an integer | |
| | | unique among all the | |
| | | nodes with that Pred or | |
| | | Nodetype. | |
| Nodetype | string | FORMULA or NOMINAL or | all non-terminal |
| | | null; all and only non- | nodes |
| | | terminal nodes have a | |
| | | Nodetype | |
| Pred | string | for terminal nodes, Pred | terminal nodes |
| | | is the lemma | |
| MaxProj | single | Maximal projection; | all nodes |
| | node | every node, whether | |
| | | terminal or nonterminal, | |
| | | should have one | |
| Refs | list of | List of possible | anaphoric |
| | nodes | antecedents for | expression |
| | | pronominals and similar | |
| | | nodes | |
| Cat | string | part of speech | terminal nodes |
| SentPunc | list of | Sentence-level | root sentence |
| | strings | punctuation | |

TABLE III
Basic LNS features

| Feature | | |
|---|---|---|
| name | Usage | Examples |
| Proposition | [+Proposition] identifies a | I left; I think he |
| | node to be interpreted as | left; I believe him |
| | having a truth value; | to have left; I |
| | declarative statement, | consider him smart; |
| | whether direct or indirect | NOT E.G. I saw him |
| | | leave; the city's |
| | | destruction amazed |
| | | me |
| YNQ | identifies a node that | Did he leave?; I |
| | denotes a yes/no question, | wonder whether he |
| | direct or indirect | left |
| WhQ | identifies a node that | Who left?; I wonder |
| | denotes a wh-question, direct | who left |
| | or indirect; marks the scope | |
| | of a wh-phrase in such a | |
| | question | |
| Imper | imperative | Leave now! |
| Def | definite | The plumber is here |
| Sing | singular | dog; mouse |
| Plur | plural | dogs; mice |
| Pass | passive | she was seen |
| ExstQuant | indicates that a quantifier | We (don't) need no |
| | or conjunction has | badges; We don't |
| | existential force, regardless | need any badges |
| | of the lexical value; e.g. in | |
| | negative sentence with | |
| | negative or negative-polarity | |
| | quantifiers; not used with | |
| | existential quantifiers that | |
| | regularly have existential | |
| | force (e.g. some); see | |
| | Section Error! Reference | |
| | source not found.. | |
| Reflex | reflexive pronoun | He admired himself |
| ReflexSens | reflexive sense of a verb | He acquitted himself |
| | distinct from non-reflexive | well |
| | senses | |
| Cleft | kernel (presupposed part) of | It was her that I |
| | a (pseudo) cleft sentence | met; who I really |
| | | want to meet is John |
| Comp | comparative adjective or | |
| | adverb | |
| Supr | superlative adjective or | |
| | adverb | |
| NegComp | negative comparative | less well |
| NegSupr | negative superlative | least well |
| PosComp | positive comparative | better |
| PosSupr | positive superlative | best |
| AsComp | equative comparative | as good as |

A number of examples may help to illustrate the structure 200 in greater detail. Assume that the natural language input is the sentence “The man ate pizza.”

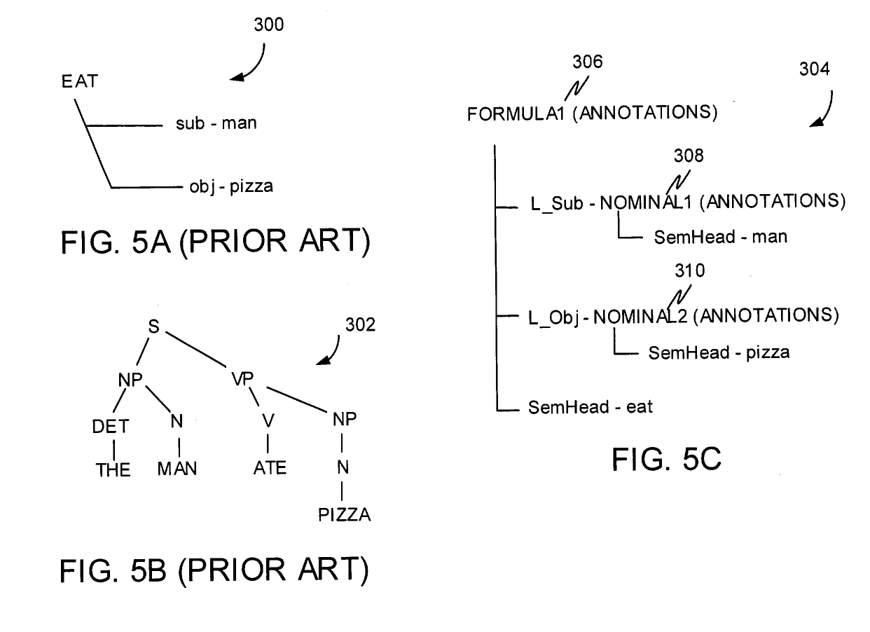

FIG. 5A illustrates a semantic dependency structure 300 generated for that sentence. Dependency structure 300 is an instance of semantic representation 206 shown in FIG. 3. The dependency structure illustrates that “man” is the subject of the head word “ate” and that “pizza” is the object. However, the dependency structure 300 tells nothing about the constituency of these words but just directly relates the head word of the sentence to the other words in the sentence.

A conventional constituency structure (or syntactic analysis) of the sentence is shown at 302 in FIG. 5B. Structure 302 is an instance of surface syntactic analysis 204 shown in FIG. 3. Substantially any known English language parser will produce a constituency analysis of the sentence that looks like constituency structure 302. Structure 302 shows that the sentence (S) is made up of a noun phrase (NP) followed by a verb phrase (VP). It also indicates that the NP is made up of a determiner (Det) which is the word “the” followed by a noun (N) which is the word “man”. Further, the VP is made up a verb (V) which is the word “ate” and another NP which is formed of a noun (N) which is the word “pizza”. Syntactic analysis 302 is a conventional constituent representation. For example, it shows that the first NP is made up of two words “the man”. Therefore, the first NP is a phrasal constituent.

Conventionally, the semantic dependency structure 300 is derived from syntactic analysis 302. It is the semantic dependency structure 300 which is abstract enough, in conventional representations, to be used by applications. However, the constituent analysis found in syntactic analysis 302 is lost in the semantic dependency structure 300.

By contrast, FIG. 5C illustrates a language neutral syntactic (LNS) representation 304 corresponding to the sentence “The man ate pizza.” LNS 304 is an instance of LNS 200 shown in FIG. 3. Structure 304 includes three nonterminal nodes 306, 308 and 310. It also includes terminal (or leaf) nodes which correspond to the lemmatized forms of the words in the sentence. The nonterminal nodes have either “NOMINAL” or “FORMULA” as a node type. It should be noted that these specific names for the nonterminal nodes are used for exemplary purposes only and any other names could be used as well.

The nonterminal nodes correspond roughly to the phrasal and sentential nodes of traditional syntactic trees. The labeled arcs between the nodes in the tree represent deep grammatical functions such as logical subject (L_Sub), logical object (L_Obj) and other semantically motivated relations such as the semantic head (SemHead) which is discussed in greater detail below.

Structure 304 illustrates that the nonterminal node FORMULA1 has a logical subject of NOMINAL1 whose semantic head is the word “man”. FORMULA1 also has a logical object NOMINAL2 which has a semantic head of “pizza” and the semantic head of the entire input is the word “eat”. It can thus be seen that structure 304 shares some features with the syntactic analysis 302 generated from a common parser. Both structures have higher level constituents (i.e., constituents that can contain more than one word). However, structure 304 is also different from the syntactic analysis 302 because the constituents in structure 304 are related to one another by unordered, labeled dependencies rather than as ordered branches (e.g., the NP in structure 302 is ordered to be prior to the VP).

It can also be seen that structure 304 shares some similarities with semantic dependency structure 300. Both structures show semantically motivated dependencies and they are unordered. However, structure 304 also uses annotated nonterminal nodes to represent constituents (i.e., FORMULA and NOMINAL) which allows the structure to maintain information that would be lost in the semantic dependency structure 300.

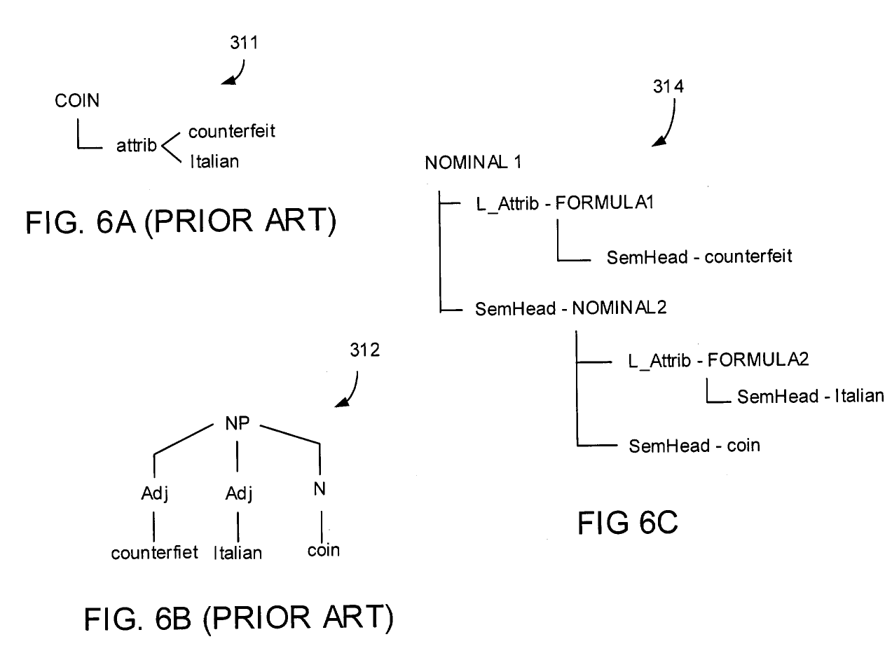

Another more complicated example may illustrate this better. Assume that the surface syntactic input is a noun phrase “counterfeit Italian coin”. FIG. 6A is a conventional semantic dependency structure 311 corresponding to that phrase. It can be seen that the word “coin” is the head and it has various attributive modifiers “counterfeit” and “Italian”. However, since the tree is unordered, it is not clear which modifier comes first. It is unclear whether the surface phrase is “an Italian counterfeit coin” or “a counterfeit Italian coin”. The semantic dependency structure has lost the ability to distinguish between these two syntactic representations, which have different meanings.

FIG. 6B illustrates a conventional syntactic analysis 312 for the same phrase. It can be seen that a syntactic analysis is a relatively flat structure indicating a noun phrase (NP) which has as its head a noun (N) “coin” and has an adjective (Adj) phrase “Italian” which precedes “coin”, and another adjective phrase (Adj) “counterfeit” which precedes “Italian”. While this structure does maintain the necessary modifier relationships, it is syntactically tied to the English language. For instance, the modifier order to obtain the same meaning in Spanish would be precisely opposite that in English.

Therefore, FIG. 6C illustrates the LNS representation 314 for the phrase “counterfeit Italian coin”. It can be seen that the nonterminal node NOMINAL2 specifically shows that the words “Italian coin” form one constituent of the representation 314. This is illustrated by the fact that both are connected to the NOMINAL2 nonterminal node by labeled arcs. Thus, NOMINAL2 represents a higher order constituent.

Similarly, representation 314 indicates that the entire term “counterfeit Italian coin” is also a constituent, indicated by the fact that both the FORMULA1 and NOMINAL2 nodes are connected directly to the NOMINALL nonterminal node by labeled arcs. This is also indicated by the fact that NOMINAL2 is the semantic head of the NOMINALL constituent and FORMULA1 is a logical attributive modifier of that constituent. Thus, it is clear that the constituent NOMINAL2 is modified by FORMULA1 which corresponds to the word “counterfeit” thus leading to the conclusion that the constituent “Italian coin” is modified by the constituent “counterfeit”. The same conclusion would be drawn regardless of whether the FORMULA1 nonterminal node was placed before or after the NOMINAL2 nonterminal node in its dependency from NOMINAL1. Similarly, the same conclusion would be drawn regardless of whether the nonterminal node FORMULA2 was placed after the SemHead coin arc from the NOMINAL2 nonterminal node.

Therefore, structure 314 represents the modifiers in proper position regardless of the particular language used to express the syntactic surface input. The structure is thus abstract enough to be substantially language-neutral, and the non-terminal nodes make the structure syntactic enough to be substantially application-neutral. For example, from structure 314, the semantic analysis 311 can be easily derived, if it is needed, for a particular application.

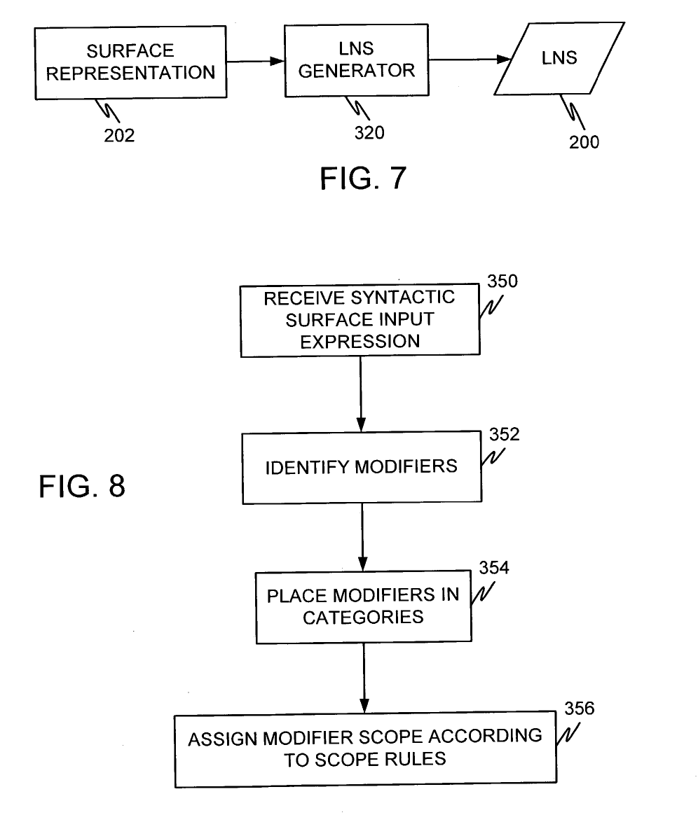

FIG. 7 is a block diagram illustrating a system for generating LNS 200 from a surface representation 202. The surface representation 202 is simply fed into an LNS generator 320 which generates LNS 200 from the surface representation. The present invention is directed to the particular structure of the representation used herein, and the actual processing used to generate the structure does not form part of the present invention, and any processing techniques can be used to generate the structure.

One technique for generating LNS 200 from a surface syntactic representation 202 utilizes the technique for generating a logical form from a syntax parse tree set out in U.S. Pat. No. 5,966,686, entitled METHOD AND SYSTEM FOR COMPUTING SEMANTIC LOGICAL FORMS FROM SYNTAX TREES, and issued on Oct. 12, 1999. Briefly, in order to generate a logical form, the system set out in the above-mentioned patent first generates a syntactic analysis structure such as surface syntactic analysis 204, which is a language specific representation showing words in linearly ordered constituents. The syntax parse tree is then revised such that it has nodes corresponding to words or phrases. For each phrase, a corresponding logical form node is created. These nodes are referred to as semnodes and a series of rules cycles through the resulting graphs to obtain semantic relations between various nodes in the graph. The rules thus assign dependency relations to obtain the semantic dependency structure (such as semantic representation 206).

In order to generate the LNS 200, this procedure is slightly modified. First, instead of applying a function to create a semnode, a constituent node is first created that has a semantic head of the semnode. This creates the basic skeleton for the constituent structure of the LNS 200. Now, instead of simply having a semnode, two records are created, one corresponding to the non-terminal constituent node and the other corresponding to the semnode and those nodes are linked by the semantic head (SemHead) relation.

The rules that were used to originally assign dependency relations were also slightly modified in order to obtain LNS 200. The prior rules assigned dependency relations between semnodes. Instead, the dependency relations are assigned between the non-terminal constituent nodes created for the phrase under analysis. Of course, these rules reflect only one way of processing text to generate LNS 200 and the present invention is not to be limited to these.

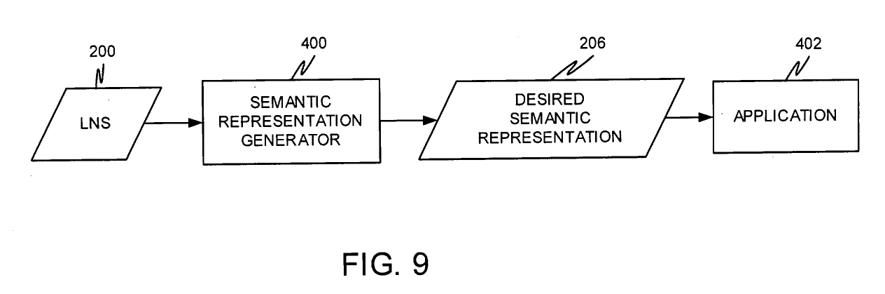

Again, the particular analysis preformed on various linguistic phenomena in order to generate an LNS structure does not form part of the present invention. Exemplary analyses of a wide variety of phenomena is set out in the Appendix hereto, but they are exemplary only. The analysis corresponding to a number of phenomena is worth mentioning in greater detail, for the sake of example and completeness only. One such phenomena is the assignment of modifier scope. Observations which have motivated one technique for assigning modifier scope are set out in greater detail in a publication entitled Campbell, COMPUTATION OF MODIFIER SCOPE IN NP BY A LANGUAGE-NEUTRAL METHOD, SCANALU Workshop, Heidelberg, Germany, 2002. However, the algorithm will be described briefly with respect to FIG. 8.

First, the syntactic surface input expression is received. This corresponds to surface representation 202 in FIG. 3 and is indicated by block 350 in FIG. 8. Next, the modifiers in the input expression are identified. This is indicated by block 352 in FIG. 8. The identification of modifiers can be performed using a conventional parser.

Next, the modifiers are placed into categories. In one embodiment, the modifiers are placed into one of three categories including nonrestrictive modifiers, quantifiers and quantifier-like_{[rgc2]} adjectives, and other modifiers. For example, nonrestrictive modifiers include postnominal relative clauses, adjective phrases and participial clauses that have some structural indication of their non-restrictiveness, such as being preceded by a comma. Quantifier-like adjectives include comparatives, superlatives, ordinals, and modifiers (such as “only”) that are marked in the dictionary as being able to occur before a determiner. Also, if a quantifier-like adjective is prenominal, then any other adjective that precedes it is treated as if it were quantifier-like. If the quantifier-like adjective is postnominal, then any other adjective that follows it is treated as if quantifier-like. Placing the modifiers in these categories is indicated by block 354 in FIG. 8.

Finally, modifier scope is assigned according to a set of derived scope rules. This is indicated by block 356.

Table 4 illustrates one set of modifier scope rules that are applied to assign modifier scope.

TABLE 4
I. Computation of modifier scope

| | |
|---|---|
| 1. | nonrestrictive modifiers have wider |
| | scope than all other groups; |
| 2. | quantifiers and quantifier-like adjectives |
| | have wider scope than other modifiers not |
| | covered in (1); |
| 3. | within each group, assign wider scope to |
| | postnominal modifiers over prenominal |
| | modifiers; |
| 4. | among postnominal modifiers in the same |
| | group, or among prenominal modifiers in |
| | the same group, assign wider scope to |
| | modifiers farther from the head noun. |

It was also found that because of lexical characteristics of certain languages, the scope assignment rules can be modified to obtain better performance. One such modification modifies the scope assignment algorithm that treats syntactically simple (unmodified) postnominal modifiers as a special case, getting assigned narrower scope than regular prenominal modifiers. This is set out in the scope assignment rules of Table 5.

TABLE 5
II. Computation of modifier scope

| | |
|---|---|
| 1. | nonrestrictive modifiers have wider scope |
| | than all other groups; |
| 2. | quantifiers and quantifier-like adjectives |
| | have wider scope than other modifiers |
| | not covered in (II.1); |
| 3. | syntactically complex postnominal |
| | modifiers that are not relative clauses have |
| | wider scope than other modifiers not |
| | covered by (II.1-2); |
| 4. | prenominal modifiers not covered by |
| | (II.1-3) have wider scope than other |
| | modifiers not covered by (II.1-3); |
| 5. | otherwise, within each group, assign wider |
| | scope to postnominal modifiers over |
| | prenominal modifiers; |
| 6. | among postnominal modifiers in the same |
| | group, or among prenominal modifiers in |
| | the same group, assign wider scope to |
| | modifiers farther from the head noun. |

The difference between these scope assignments rules and those found in Table 4 lies in steps 3 and 4 in Table 5. These steps ensure that syntactically complex postnominal modifiers have wider scope than non-quantificational prenominal modifiers, and that prenominal modifiers have wider scope than syntactically simple postnominal modifiers. Implementing the rules set out in Table 5 has been observed to significantly reduce the number of French and Spanish errors in one example set.

In applying these rules, it may be desirable for quantifiers to be distinguished from adjectives, adjectives to be identified as superlative, comparative, ordinal or as able to occur before a determiner, and postnominal modifiers to be marked as non-restrictive. However, even in languages where the third requirement is not easily met, the scope assignment rules work relatively well.

Another phenomena worth noting in greater detail is the analysis of temporal information (i.e., tense). A full discussion of analyzing this phenomena is set out in Campbell et al., A LANGUAGE-NEUTRAL REPRESENTATION OF TEMPORAL INFORMATION, Coling (2002). However, a brief discussion of analysis of tense is provided here simply for the sake of example.

The LNS representation of semantic tense illustratively satisfies two criteria:

1. Each individual grammatical tense in each language is recoverable from the LNS representation; and

2. The explicit sequence of events entailed by a sentence is recoverable from the LNS representation by a language-independent function.

Basically, the first criterion_{[rgc3]} indicates that the LNS representation can be used to reconstruct, by a distinct generation function for each language, how the semantic tense was expressed in the surface form of that language. This is satisfied if the LNS representation is different for each tense in a particular language.

The second criterion_{[rgc4]} indicates that the LNS representation can be used to derive an explicit representation of the sequence of events by means of a language-independent function. This is satisfied when the LNS representation of each tense in each language is language-neutral.

In one illustrative embodiment, each tensed clause in the surface syntax representation contains one or more tense nodes in a distinct relation (such as the L_tense or “logical tense” relation) _{[rgc5]}with the clause_{[rgc6]}. A tense node is specified with semantic tense features, representing the meaning of each particular tense, and attributes indicating its relation to other nodes (including other tense nodes) in the LNS representation. Table 6 illustrates the basic global tense features, along with their interpretations, and Table 7 illustrates the basic anchorable features, along with their interpretations. The “U” stands for the utterance time, or speech time.

TABLE 6

| Feature | Meaning |
|---|---|
| G_Past | before U |
| G_NonPast | not before U |
| G_Future | after U |

TABLE 7

| Feature | Meaning |
|---|---|
| Befor | before Anchr if there is |
| | one; otherwise before U |
| NonBefor | not before Anchr if there |
| | is one; otherwise not |
| | before U |
| Aftr | after Anchr if there is |
| | one; otherwise after U |
| NonAftr | not after Anchr if there |
| | is one; otherwise not |
| | after U |

The tense features of a given tense node are determined on a language-particular basis according to the interpretation of individual grammatical tenses. For example, the simple past tense in English is [+G_Past], and the simple present tense is [+G_NonPast] [+NonBefor], etc. Of course, additional features can be added as well. Many languages make a grammatical distinction between immediate future and general future tense, or between recent past and remote or general past. The present framework is flexible enough to accommodate tense features, as necessary.

In one embodiment, a tense node T will also, under certain conditions, include a non-tree attribute (such as one referred to as “ANCHR”). The non-tree attribute indicates a relation that the node T bears to some other tense node. By non-tree attribute, it is meant that the attribute is thought of as an annotation on the basic tree, and not as part of the tree itself. For example, the value of the ANCHR attribute must fit into the LNS representation tree in some independent way. A tense node will have a ANCHR attribute if (a) it has anchorable tense features; and (b) it meets certain structural conditions. For simple tenses, the structural condition that it must meet to have an ANCHR attribute is that the clause containing it is an argument (i.e., a logical subject or object) of another clause. In that case, the value of ANCHR is the tense node in the governing clause. This set of sufficient structural conditions for having the ANCHR attribute is described in greater detail in the paper mentioned above, and in the appendix hereto.

It should again be noted that the illustrative analyses of a variety of different linguistic phenomena are set out in the appendix hereto. The particular way in which these phenomena are analyzed in the appendix does not form part of the invention, and it will be noted that they could be analyzed in any other suitable way_{[rgc7]} as well. However, the appendix is provided simply for the sake of example.

FIG. 9 is a block diagram illustrating how LNS representation 200 is processed for use in one of any number of applications. FIG. 9 illustrates that LNS representation 200 is provided to a semantic representation generator 400. Semantic representation generator 400 generates a desired semantic representation 206, which is needed by a particular application 402. The desired semantic representation 206 is then provided to the application 402 for use.

In fact, there may well be multiple semantic representations, which can be derived from LNS representation 200, each required by different applications and each perhaps expressing different kinds of semantic properties. LNS representation 200 contains as much information about the surface syntax of a given sentence as is needed to derive such semantic representations, without additional surface-syntactic information.

One example of a semantic representation that can be used is referred to as a Predicate-Argument Structure (PAS) which is a graph showing the lexical dependencies inherent in the LNS representation 200 in a local fashion. The PAS corresponds to the logical form discussed above with respect to U.S. Pat. No. 5,966,686.

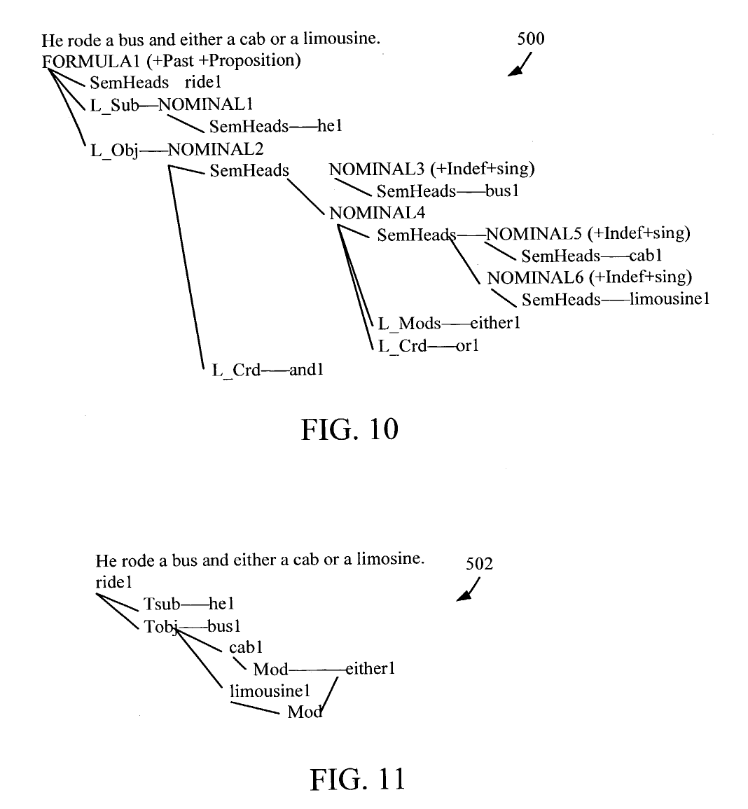

Consider, for example, the sentence “He rode a bus and either a cab or a limousine.” Which has an LNS representation 500 shown in FIG. 10. The relation between “ride” and the various nouns in the coordinate NP is indirect. Also, in general, the path between say a predicate and the various conjoined nouns in that predicate's argument is arbitrarily long in the LNS representation 500. However, a given application 402 may need to make use of such relations.

For example, the given application may need to make use of these relations in determining that “bus”, “cab” and “limousine” are all things that one commonly rides. The PAS provides just such a representation. FIG. 11 shows the PAS 502 for the same sentence. In this representation, all three nouns are the value of the PAS-only attribute “Tobj” of node “ride1”. This indicates that they are typical objects of “ride”.

No matter how complex the coordinate structure in LNS representation 500, the PAS representation represents only the lexical dependencies, and the structure is flattened. Additional examples of processing LNS representations into semantic representations, or other representations desired by applications, is discussed in greater detail in the appendix hereto.

It can thus be seen that the LNS representation of the present invention occupies a middle ground between surface-based syntax and a full-fledged semantic representation. The LNS representation is neither a comprehensive semantic representation, nor a syntactic representation of a particular language, but is instead a semantically motivated, substantially language-neutral syntactic representation. The LNS representation represents the logical arrangements of the parts of a sentence, independent of arbitrary, language-particular aspects of structure such as word order, inflectional morphology, function words, etc. The LNS representation strikes a balance between being abstract enough to be substantially language-neutral, but still preserving potentially meaningful surface distinctions.

Although the present invention has been described with reference to particular embodiments, workers skilled in the art will recognize that changes may be made in form and detail without departing from the spirit and scope of the invention.

What is claimed is:

1. A data structure representing a surface textual string of words, for use in providing inputs to applications, the data structure comprising:
an annotated tree including nodes, each having at most one parent node, the nodes comprising terminal nodes and non-terminal nodes, the non-terminal nodes representing a constituent, and a branch connecting a node to a parent thereof, each branch being labeled with a label indicative of a semantic relation between the connected nodes.

2. The data structure of claim 1 wherein the terminal nodes correspond to lemmas of the words in the textual string.

3. The data structure of claim 1 wherein the non-terminal nodes are structured to represent constituents corresponding to a plurality of the words in the textual string.

4. The data structure of claim 1 wherein the labels establish a dominance relation among the nodes.

5. The data structure of claim 1 wherein the nodes are annotated with features, the features being indicative of linguistic characteristics of the corresponding node.

6. The data structure of claim 1 and further comprising:
a non-tree attribute that is indicative of a non-local dependency between a node to which the non-tree attribute is connected and at least one other node._{[rgc8]}

7. The data structure of claim 1 wherein the branches are unordered.

8. The data structure of claim 1 wherein the words in the textual string include function words and wherein the tree structure further comprises:
features representative of at least a subset of the function words.

9. The data structure of claim 5 wherein the annotated nodes are structured to represent abstract expressions that are implicit in the surface textual string.

10. The data structure of claim 3 wherein the non-terminal nodes represent constituents to indicate modifier scope.

11. A computer readable medium storing a data structure for use in generating an input, representative of a textual input string of words, to an application, the data structure comprising:
a tree structure comprising:
a plurality of unordered branches connecting nodes, the nodes including at least one non-terminal node and at least one terminal node, the non-terminal nodes representing constituents in the textual input string, and each branch including a label indicative of a semantic relationship between nodes connected by the branch.

12. The computer readable medium of claim 11 wherein terminal nodes in the tree structure comprise lemmas of the words in the textual input string.

13. The computer readable medium of claim 11 wherein the constituents include high order constituents that each correspond to a plurality of the words in the textual input string.

14. The computer readable medium of claim 11 wherein nodes in the tree structure are annotated with features that are indicative of linguistic characteristics of the nodes.

15. The computer readable medium of claim 1 wherein the branches that connect non-terminal nodes to one another are labeled to indicate a semantic relation between constituents.

16. The computer readable medium of claim 11 and further comprising:
an attribute indicative of non-local dependencies between a corresponding node to which the attribute is connected and another node in the tree structure._{[rgc9]}

17. A computer readable data structure representative of a surface syntactic input, for use as an input to an application, comprising:
an unordered, hierarchical arrangement of nodes including non-terminal nodes representative of multiple word constituents of the syntactic input, the nodes being connected by branches labeled to indicate a semantic role of one node connected by the branch relative to another node connected by the branch.

18. The computer readable data structure of claim 17 wherein the nodes are annotated with features indicative of linguistic characteristics of the node.

19. The computer readable data structure of claim 17 wherein the nodes include terminal nodes that are lemmas of words in the syntactic input.

20. The computer readable data structure of claim 18 wherein the features are indicative of function words in the syntactic input.

21. The computer readable data structure of claim 17 wherein the arrangement includes attributes indicative of non-local dependencies between a node to which an attribute is connected and another node to which the attribute is not connected.

22. The computer readable data structure of claim 17 wherein the arrangement of nodes is processable into the input to the application.

23. The computer readable data structure of claim 22 wherein the application generates a human understandable expression based on the processed arrangement of nodes.
